(19) United States
(12) Patent Application Publication
(10) Pub. No.: US 2019/0304347 A1
(43) Pub. Date: Oct. 3, 2019

(54) GUIDE SYSTEM

(71) Applicant: Sam Klindt, Altoona, IA (US)

(72) Inventor: Sam Klindt, Altoona, IA (US)

(21) Appl. No.: 16/369,999

(22) Filed: Mar. 29, 2019

Related U.S. Application Data
(60) Provisional application No. 62/650,553, filed on Mar. 30, 2018.

(51) Int. Cl. G09F 13/16; G09F 13/20

(52) U.S. Cl. CPC G09F 13/16; G09F 13/20

(57) ABSTRACT

A guide system includes a plurality of posts having a first end and a second end. The first end has a tapered section that terminates into an elongated section. The elongated section terminates into a gripping section. The posts are stored in a guide system case having a plurality of sleeves that receive the posts.

### CROSS REFERENCE TO RELATED APPLICATION

This application claims the benefit of the priority of U.S. Provisional Application No. 62/650,553 filed on Mar. 30, 2018, the contents of these applications are hereby incorporated by reference in their entirety.

### BACKGROUND OF THE INVENTION

This invention is directed toward a guide system for tracking and locational purposes. More specifically, and without limitation, this invention relates to a guide post system that allows individuals to trek an unknown area to a desired location and back to an original location. For example, when a hunter successfully targets and hits their game, the location of the game may be, and usually is, a distance away from the hunter. The hunter must then track and find the location of the fallen game and then be able to successfully return to their original location. This trek may occur at night where visibility is low and disorientation in an unknown area is likely.

Trail marking systems are well known in the art. One advancement that has taken place is the use of lead lines consisting of tape, rope, and wire attached to stakes or directly to trees or brush. Another advancement has been the use of paint and paint-like materials that are used to mark individual trees or pathways leading to the fallen game. These designs have their deficiencies however. The lead line models can become entangled, damaged by wildlife or the elements, and require additional components such as stakes and a means to properly insert the stakes such as a hammer. The paint models do not form a direct path to the game and are more permanent on the trees and plant life. For example, the path may be useful to track one game on one day but can become confused with additional markings when the hunter returns to the same location the next day or when other hunters use the location for their purposes. Additionally, paint models may be harmful to the environment and are not reusable.

On solution to this problem, however, is the use of vinyl clip markers that are attached to trees or other plant life. Despite these advances and others, problems still remain. In particular, the vinyl clips are small and not as visible from a distance greater than a few feet. Additionally, the clips do not create a clear continuous path as they have to be anchored to natural fauna.

Thus it is a primary objective of this invention to provide a guide system that improves upon the art.

Another objective of this invention is to provide a guide system that is reusable.

Yet another objective of this invention is to provide a guide system that is easily removable from a ground surface.

Another objective of this invention is to provide a guide system that is stable against the elements when inserted into the ground.

Yet another objective of this invention is to provide a guide system that is reflective.

Another objective of this invention is to provide a guide system that is visible at night.

Yet another objective of this invention is to provide a guide system that can be easily inserted into frozen ground.

Another objective of this invention is to provide a guide system that leads directly to the position of fallen game.

Yet another objective of this invention is to provide a guide system that does not require wet materials.

Another objective of this invention is to provide a guide system that does not require a driving implement such as a hammer.

Yet another objective of this invention is to provide a guide system that is light weight.

Another objective of this invention is to provide a guide system that leaves little mark on the environment.

These and other objectives, features, and advantages of the invention will become apparent from the specification.

### SUMMARY OF THE INVENTION

A guide system includes a plurality of posts having a first end and a second end. At one end is a tapered section which terminates into an elongated section. The elongated section terminates into a gripping section at the opposite end. At least a portion of the post is covered in a reflective coating or tape.

The plurality of posts are stored in a portable case. The case has a plurality of sleeves adapted to receive the plurality of posts. When in a rolled position, the posts can be accessed from the side edges of the case.

### BRIEF DESCRIPTION OF THE DRAWINGS

FIG. 1 is a top plan view of a guide system;

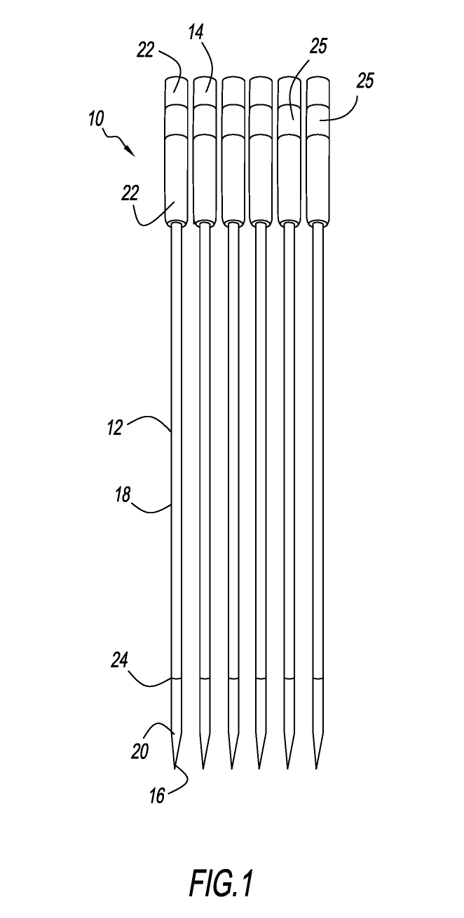

FIG. 2 is a top plan view of a case for a guide system; and

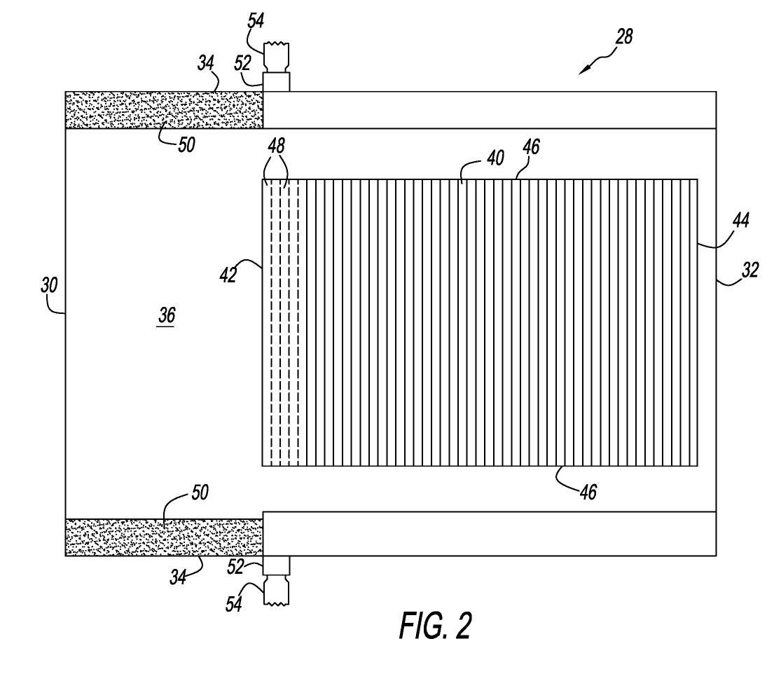

FIG. 3 is a bottom plan view of a guide system.

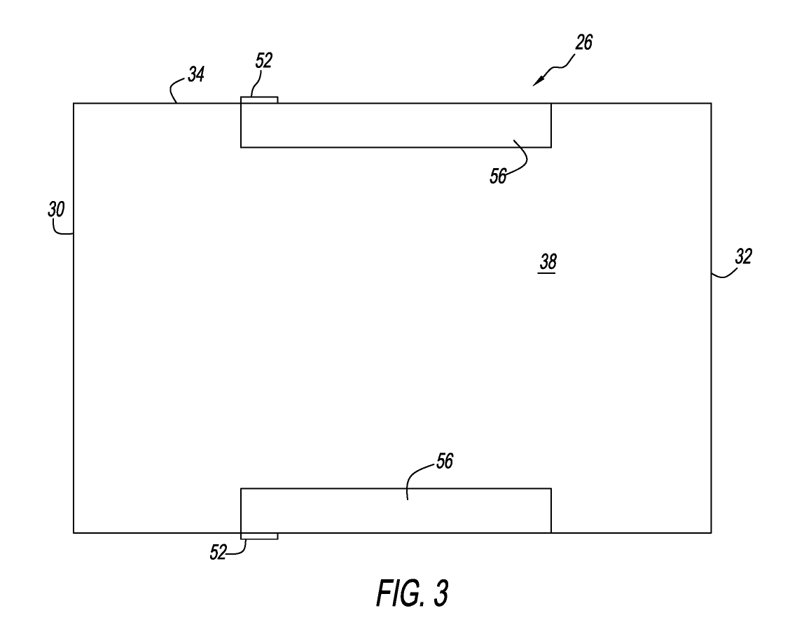

### DETAILED DESCRIPTION OF THE PREFERRED EMBODIMENT

With reference to the figures a guide system 10 is shown having a plurality of guide posts 12. Each guide post 12 has a first end 14 and a second end 16. Each guide post 12 also includes an elongated section 18 and a tapered section 20 positioned between the first end 14 and the second end 16. The first end 14 terminates in a gripping extension 22.

Each guide post 12 may be coated or covered either partially or completely in a reflective coating or covering. In one embodiment, the guide posts 12 are coated in a luminescent glow material for use of the guide system 10 at night. In another embodiment, only the gripping extension is coated or covered in a reflective or glow material. In another embodiment, the guide post 12 is a uniform body. The guide post 12 may be of any sturdy material such as wood, metal, dense poly-plastic or combination thereof. In one embodiment, the guide post 12 is metal in order to pierce frozen ground. In one instance, the guide post 12 is hollow in order to provide a lightweight guide system 10. In yet another embodiment, the guide post 12 is of a material that is reusable after insertion into and removal from a ground surface. When inserted into the ground, the guide post 12 is substantially visible from a standing position in wooded or similar high-brush, obstructed, and unknown areas. The guide post 12 may be smooth or rough to the touch.

The first end 14 terminates in a gripping extension 22 positioned between the first end 14 and the elongated section 18. In one embodiment, the gripping extension 22 is a bead. In another embodiment, the gripping extension 22 is a bulbous, grippable form and the like. In yet another embodiment, the gripping extension 22 is a “t” section perpendicular to the elongated section 18. In yet another embodiment, the gripping extension 22 is ergonomic. The gripping portion 22 may also have a reflective band 25 attached.

The elongated section 18 extends between the gripping extension 22 and the tapered section 20. Along the elongated section 18 is the insertion guide line 24. The insertion guide line 24 provides the depth at which the guide post 12 is inserted into a ground surface along a path. In one embodiment, the insertion guide line 24 is no more than two inches from the second end 16 such that no more than two inches of the guide post is inserted into a ground surface. This depth allows proper insertion of the guide post 12 for stability while in the ground and also for easy removal of the guide post 12 from the ground surface with little impact or mark on the environment. The elongated section 18 terminates in the tapered section 20.

The tapered section 20 is positioned between the elongated section 18 and the second end 16. The second end 16 terminates in a point, a snip, or similar terminus that allows for piercing either frozen or thawed ground surfaces.

In operation, an individual begins in an original position and has a desired location. In one embodiment, the desired location is where the fallen prey is positioned. The individual grips the gipping extension 22 and perpendicularly inserts the guide post 12 with the second end 16 piercing the ground surface first, along a path between the original position and the desired location. The user then returns to the original position by following the guide system 10 along the path created by the guide system 10 back toward the original position. The individual removes each guide post 12 from the ground and collects them for reuse along the path while passing the guide post 12 on the way back to the original position. The gripping extension 22 of the posts 12 is a ⅝ inch diameter wooden dowel material 3 inches in length, bearing a ¾ inch wide reflective band 25 (for increased night visibility) installed 360 degrees around the entire circumference of the gripping extension 22 and starting ½ inch below the top of the end. The entire post 12 and tip is painted a fluorescent orange with only the reflective band 25 around the top of the gripping extension 22.

When not in use, the guide system 10 is stored in a portable case 26. The portable case is of any size, shape, and structure. In one example, the portable case 26 includes a layer of material 28 having a first end 30, a second end 32, side edges 34, a first or inner surface 36 and a second or outer surface 38.

Attached to the inner surface 36 of case 26 is a second layer of material 40. The second layer of material 40 is smaller than the layer of material 28 and has a first end 42, a second end 44, and side edges 46. The second layer 40 has a plurality of sleeves 48 adapted to receive the guide system 10 that are formed by stiches that are parallel to ends 42 and 44 and extend between the side edges 46 of the second layer 40.

Adjacent the first end 30 and side edges 34 is a connecting member 50 such as a strip of hooks and loops or the like. Also, attached to the side edges 34 in spaced alignment are a pair of loops 52 adapted to receive a strap 54.

On the second surface 38, adjacent the side edges 34, between the first 30 and second end 32 is a connecting member 56 that matingly connects to connecting member 50.

In operation, the posts 12 are inserted into the sleeves 48 such that the gripping portion 22 remains exposed. Once placed, the first end 30 is rolled so that the first surface 36 engages the second surface 38 and connecting member 50 connects to connecting member 56 forming a cylindrical shape. When the strap 54 is placed over one's shoulder the gripping portion 22 can be seen and accessed through the side edges 34.

Therefore, a guide system 10 has been provided that provides tracking and locational pathway guidance, and improves upon the art.

From the above discussion and accompanying figures it will be appreciated that the guide system 10 offers many advantages over the prior art. It will be appreciated further by those skilled in the art that other various modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. A guide system, comprising:
a plurality of posts having a first end and a second end;
the first end having a tapered section that terminates into an elongated section; and
the elongated section terminates into a gripping section, and wherein at least a portion of the post is covered in a reflective covering.

2. The system of claim 1 wherein the entire post is coated in a luminescent glow material.

3. The system of claim 1 wherein only the gripping portion is covered in a reflective covering.

4. The system of claim 1 wherein the gripping portion has a band of reflective tape.

5. The system of claim 1 further comprising a case adapted for storing the plurality of posts.

6. The system of claim 5 wherein the case is adapted to provide access to the posts when the case is rolled up.
